(19) United States
(12) Patent Application Publication
(10) Pub. No.: US 2007/0170204 A1
(43) Pub. Date: Jul. 26, 2007

(54) DISPENSER LOW QUANTITY INDICATOR

(76) Inventor: Frederick W. Gibb, Severna Park, MD (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/307,188

(22) Filed: Jan. 26, 2006

(51) Int. Cl. B67D 5/06

(52) U.S. Cl. 222/23

(57) ABSTRACT

A dispenser apparatus comprises a container that maintains and dispenses a product. In one embodiment, a first portion of the product can have a first color and a second portion of the product can have a second color. In this embodiment, the first portion of the product is positioned relative to the second portion of the product within the container, and relative to the outlet of the container, such that a predetermined quantity of the first portion of the product exits the outlet of the container before the second portion of the product exits the outlet of the container. The second portion of the product comprises the product and a marker which changes the color of the product. The second color is visually distinguishable from the first color, and this provides the user with a visual indication that the dispenser is almost empty and needs to be replaced.

### BACKGROUND

1. Field of the Invention

Embodiments herein generally relate to methods and apparatuses for containing and dispensing products.

2. Description of Related Art

Many different forms of pressurized and unpressurized containers are utilized to maintain products such as gels, liquids, solids, gases, pastes, creams, lotions, oils, sprays, etc. until they need to be dispensed. Some of these containers are transparent or contain transparent portions that allow a user to know how much of the product remains in the container. For example, U.S. Patent Publication 2005/0199744 (incorporated herein by reference) describes an aerosol container having a capillary to indicate the volume of product remaining. However, many containers are not transparent or translucent which leaves the user to ponder the amount remaining in the container from the approximate weight and/or ejection power of the container. This often results in the user running out of product at an inconvenient time or location. Therefore, there is a need to provide the user with a warning that the product within the container is about to run out, so that the user can obtain a full container before the old container becomes completely empty.

### SUMMARY

Embodiments herein provide an apparatus for dispensing a product that can be pressurized or unpressurized, such as gels, liquids, solids, gases, pastes, creams, lotions, oils, sprays, etc. The dispenser apparatus comprises a container that maintains (contains) the product. In one embodiment, a first portion of the product can have a first color and a second portion of the product can have a second color. In this embodiment, the first portion of the product is positioned relative to the second portion of the product within the container, and relative to the outlet of the container, such that a predetermined quantity of the first portion of the product (e.g., a large portion or substantially all of the first portion of the product) exits the outlet of the container before the second portion of the product exits the outlet of the container. The second portion of the product comprises the product and a marker which changes the color of the product. The second color is visually distinguishable from the first color, and this provides the user with a visual indication that the dispenser is almost empty and needs to be replaced.

Another embodiment herein includes a divider within the container separating the first portion of the product from the second portion of the product. The first portion of the product and the second portion of the product are positioned with respect to the divider and to the outlet such that the predetermined quantity of the first portion of the product exits the outlet of the container before the second portion of the product exits the outlet of the container. The divider can comprise a structure that ruptures when the predetermined quantity of the first portion of the product has exited the container. Therefore, again, the predetermined quantity of the first portion of the product exits the outlet of the container before the second portion of the product exits the outlet of the container.

In another embodiment that uses a divider, the container can maintain the product and a colored marker. In this embodiment, the divider within the container separates the product from the marker, until the predetermined quantity of the product has exited the container, at which time the divider ruptures and colors the remaining product within the container. The marker has a physical characteristic that mixes with the product to change the color of the product from a first color to a second color after the marker is released from the divider.

Another embodiment maintains the marker or a different colored product within a sub-container (e.g., divider sack/bubble) within the container. Again, the divider sack/bubble comprises a structure that ruptures after a predetermined quantity of the product has exited the container. The divider sack/bubble can be loose within the container or can remain attached to the container. For example, the divider sack/bubble can remain attached to the fill hole of the container.

Methods for making the above apparatus embodiments are many. In one method embodiment, the product is added to the container and a colored marker is added to the container to leave the first portion of the product with the first color and the second portion of the product with the second color. When so adding the product and the colored marker, the process is performed in a manner such that the first portion of the product is positioned relative to the second portion of the product within the container such that the predetermined quantity of the first portion of the product exits the outlet of the container before the second portion of the product exits the outlet of the container. Again, the process of adding the colored marker changes the color of the second portion from the first color to the second color. However, in another embodiment, rather than adding the colored marker, the different colored product (second color) is added after the first colored product is added.

An alternative method embodiment adds a divider to the container, adds the product to a container, and adds a colored marker to the container (not necessarily in that order) such that the product is separated from the marker by the divider. Again, the divider comprises a structure that ruptures after the predetermined quantity of the product has exited the container and the marker has a physical characteristic that mixes with the product to change a color of the product from a first color to a second color after the divider ruptures. An additional method embodiment adds the product to the container, adds (or creates) a divider sack/bubble to the container, and fills the divider sack/bubble with a colored marker. The divider sack/bubble can be filled before or after being added to the container. These and other features are described in, or are apparent from, the following detailed description.

### BRIEF DESCRIPTION OF THE DRAWINGS

Various exemplary embodiments of the apparatuses and methods are described in detail below, with reference to the attached drawing figures, in which:

FIGS. 1 and 2 are cross-sectional schematic representations of a container/dispenser according to embodiments herein;

FIGS. 3 and 4 are cross-sectional schematic representations of a container/dispenser having a dip tube according to embodiments herein;

FIGS. 5 and 6 are cross-sectional schematic representations of a container/dispenser according to embodiments herein;

FIGS. 7-9 are cross-sectional schematic representations of a container/dispenser having a dip tube according to embodiments herein;

FIGS. 10-12 are cross-sectional schematic representations of a container/dispenser according to embodiments herein;

FIGS. 13 and 14 are cross-sectional schematic representations of a container/dispenser having a dip tube according to embodiments herein;

FIGS. 15 and 16 are cross-sectional schematic representations of a container/dispenser according to embodiments herein;

FIGS. 17 and 18 are cross-sectional schematic representations of a container/dispenser having a dip tube according to embodiments herein; and

FIG. 19-22 are flow charts illustrating method embodiments herein.

### DETAILED DESCRIPTION

It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

As mentioned above, there is a need to provide the user with a warning that the product within the container is about to run out so that the user can obtain a full container before the previous container becomes completely empty. The embodiments herein address this need by providing a visual indicator to the user by changing the color of the product as the container empties.

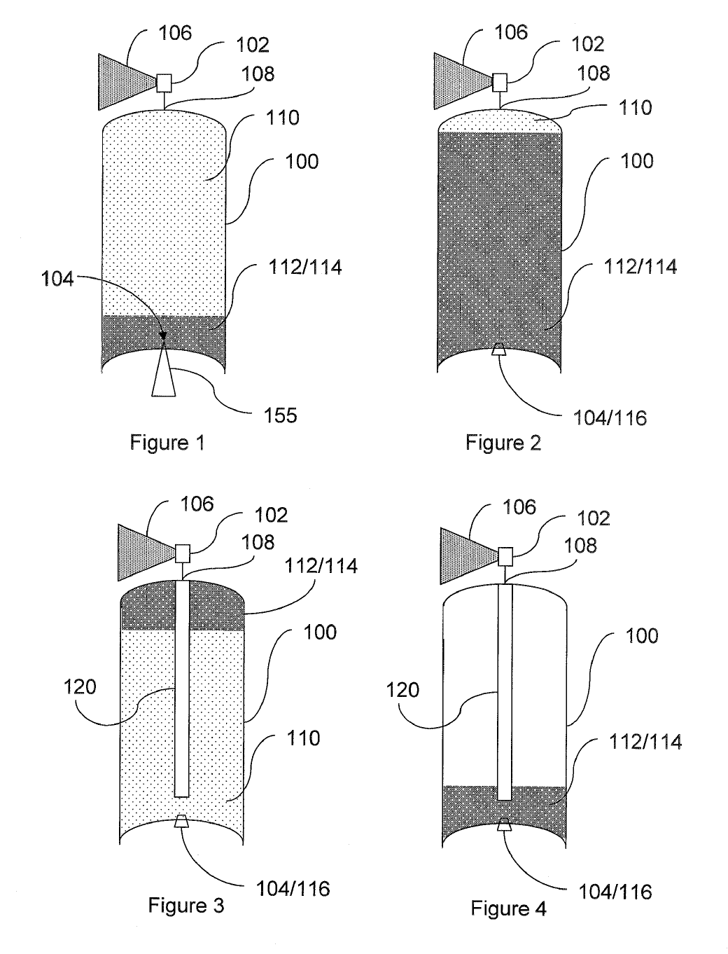

More specifically, as shown for example in FIGS. 1-18, embodiments herein provide apparatuses for dispensing a product that can be stored in pressurized or unpressurized containers 100. The products can comprise any types of items, such as but not limited to gels, liquids, solids, gases, pastes, creams, lotions, oils, sprays, etc.

Many different forms of dispensers are well-known and are commercially available from manufacturers such as United States Can Company (Lombard, Ill., USA). The details of such containers are not discussed at length herein to focus the reader on the salient features of the embodiments herein; however, the embodiments herein are applicable to all types of pressurized and unpressurized containers (those having pressurized environments and those having unpressurized environments, compared to one atmospheric pressure) such as, but not limited to, the examples referenced below. For example, U.S. Pat. Nos. 6,880,732 and 6,386,400 (incorporated herein by reference) describe a piston-type pressurized container; U.S. Pat. No. 6,786,370 (incorporated herein by reference) describes a top-filled pressurized container having a dip tube; U.S. Pat. No. 6,571,835 (incorporated herein by reference) describes a method of filling a pressurized container; U.S. Pat. No. 5,339,990 (incorporated herein by reference) describes an unpressurized container that uses a hand pump to draw the product out of the container; and U.S. Patent Publication 2005/0138814 (incorporated herein by reference) describes a mechanical apparatus combined with a container.

In embodiments shown in FIGS. 1-4, a first portion 110 of the product can have a first color and a second portion 112 of the product can have a second color. FIGS. 1 and 2 illustrate an embodiment where the product directly exits an outlet 108. In FIG. 1, the operation of the release valve or pump 102 causes product (contents of the container) to be dispensed to an exterior environment outside the container 100 (represented by item 106) from the top of the container 100 to the bottom of the container 100 (e.g., top-first exiting container). Therefore, in the direct exit structure shown in FIG. 1, product in the top of the container 100 will be consumed (exit) before the product in the bottom of the container 100, as shown in FIG. 2 where most of the first portion 110 has exited the container 100. Thus, in the structure shown in FIG. 1, the second portion 112 of the product that has a warning indicator color is located in the bottom of the container 100 so that it will exit the container 100 (e.g., only) after the predetermined quantity of the first portion 110 of the product has exited the container 100. While the terms top (toward the outlet 108), bottom (toward the fill hole 104), above, below, etc. are used herein to describe the relative positions of the container and items in the container, as would be understood by one ordinarily skilled in the art the normal usage of the container could be at a different position or orientation. In such situations, the relative positions of the items described herein and the operations of embodiments herein would be the same (considering the effects of pressure, suction, gravity, etc.). Therefore, the terms top, bottom, above, below, etc. are not intended to limit the invention in any way, but instead are merely used to facilitate further understanding of the invention (through examples) using common, easily understood terminology.

To the contrary, in structure shown in FIGS. 3-4, a dip tube 120 is connected to the outlet 108. Therefore, in the structure shown in FIGS. 3-4, the product will be drawn out of the bottom of the container 100 through the dip tube 120 in a bottom-first exiting manner. Therefore, in the structure shown in FIGS. 3-4, product in the bottom of the container 100 will be consumed (exit) before the product in the top of the container 100, as shown in FIG. 4 where all the first portion 110 has exited and only the second portion 112 remains to be dispensed through the dip tube 120. Thus, in the structure shown in FIG. 2, the second portion 112 of the product that has the warning indicator color is located in the top of the container so that it will exit the container 100 (e.g., only) after the first portion 110 of the product has exited the container 100.

Thus, as shown in FIGS. 1 and 3, when the container is full and before portions of the product are released from the container, the first portion 110 of the product is positioned relative to the second portion 112 of the product within the container 100, and relative to the outlet 108 of the container 100, such that the predetermined quantity of the first portion 110 of the product (e.g., a large portion or substantially all of the first portion 110 of the product) exits the outlet of the container 100 before the second portion 112 of the product exits the outlet of the container 100.

With respect to the terminology “predetermined quantity”, “substantially all,” etc., while some of the first portion 110 of the product may always remain in the container 100 or may mix with a small amount of the second portion 112 as the second portion 112 exits the container, most or the predetermined quantity (e.g. greater than 25%, greater than 50%, greater than 75%, greater than 90%, greater than 95%, greater than 99%, etc.) of the original, unaltered, originally colored product (first portion 110) exits the container before the color changed portion of the product (second portion 112) begins to exit the container. Thus, with embodiments herein, the first portion 110 is maintained separate from the second portion 112 throughout most (or an acceptable portion) of the useful life of the container.

The second portion 112 of the product comprises the product mixed with a marker 114 which changes the color of the product. The marker 114 can be any coloring agent including but not limited to commercial dyes, food coloring dyes, cosmetic dyes, etc., whether now known or developed in the future. The marker 114 can have the second color or can have material properties (be adapted to) change the color of the product from the first color to the second color (or the marker 114 can both have the color and be adapted to change the color of the product to the second color). The second color is visually distinguishable from the first color, and this provides the user with a visual indication that the dispenser is almost empty and needs to be replaced. In some embodiments the coloring agent or the marker is absent from the first portion (e.g., the process of adding the coloring agent avoids adding the coloring agent to the first portion); however, in other embodiments, some of the coloring agent or some of its components could be included within the first portion, so long as the first and second portions are visually distinguishable. Further, in some embodiments, the only difference between the first portion 110 and the second portion 112 is the presence of the marker 114 in the second portion 112; however, in other embodiments there are additional differences between the first portion 110 and the second portion 112. Thus, the color of the second portion 112 and of the marker 114 will vary depending upon specific application. It may be helpful to select the color to be distinct enough to be easily recognized by the user, yet it may not be helpful (but not necessary) to select a marker 114 substance that would be harmful (caustic, poisonous, irritating, etc.) or displeasing in appearance. In addition, it may be helpful for the packaging of the container to relate to the user that the change in appearance (color) of the product indicates that the product is beginning to run out and that more product should be obtained.

The quantity ratio of the first portion 110 to the second portion 112 determines the quantity of first portion 110 that must exit the container before the second portion 112 begins to exit. This quantity ratio will vary depending upon the specific product, its method of application, and the manufacturer's determination of appropriate timing for the “low quantity” indicator to begin to appear. Therefore, the ratio of the first portion 110 to the second portion 112 will vary depending upon application. For example, some manufacturers may desire to provide the low quantity colored indicator warning when less than one-quarter, less than one-third, less than one-half, etc. of the product has been consumed (exited), while other manufacturers may desire to wait until more than one-half, more than two-thirds, more than three-quarters, etc. of the first portion 110 of the product has been consumed (exited) before providing the low quantity change in color warning as described herein. The invention is applicable to all such ratios and all “predetermined quantities” and is not limited to the examples discussed herein.

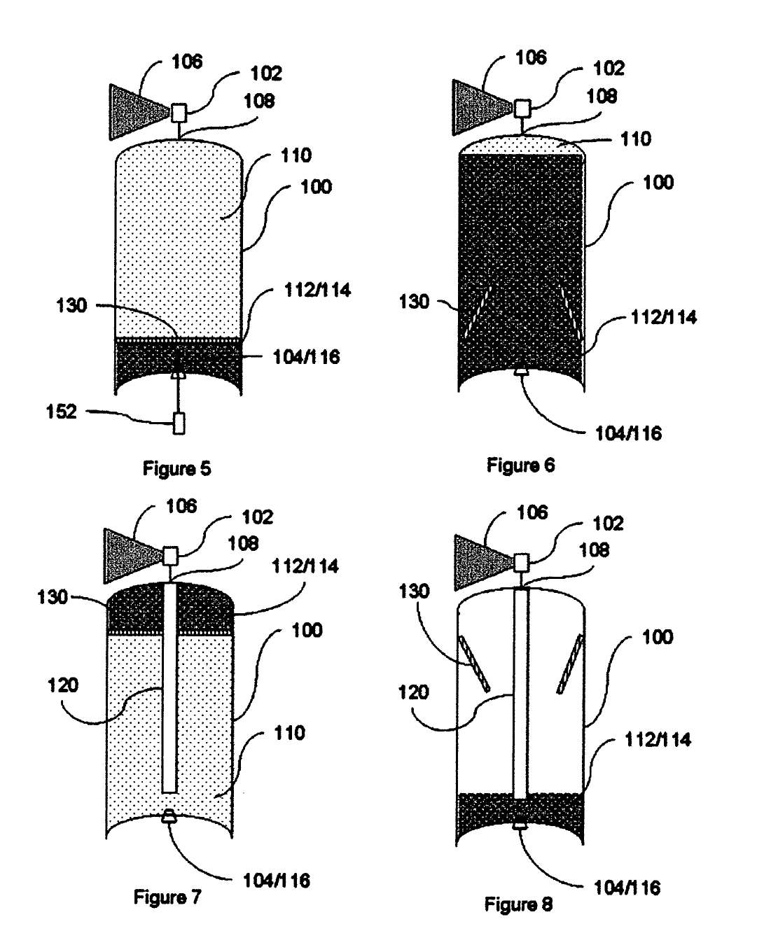

In some applications, the first portion 110 may undesirably mix with the second portion 112 during manufacturing, transportation, or at other times before or during the product's useful life. This is especially true in unpressurized containers where the pump 102 is hand pumped to draw product out of the container through the dip tube 120. Therefore, as shown in FIGS. 5-9, other embodiments herein include a repturable divider layer 130 (being adapted to rupture, having the physical characteristic of being able to rupture, having an intentional structural weakness that is designed to reliably fail at a given condition, etc.) such as a membrane within the container 100 (and potentially connected to the inner sides of the container 100) separating the first portion 110 of the product from the second portion 112 of the product, which prevents undesirable mixing of the first portion 110 and the second portion 112 until the appropriate time.

The use of divider devices within containers is known conventionally and a detailed discussion of the same is not included herein so as to focus the reader on the salient points of the embodiments herein. Any type of divider material can be utilized with embodiments herein such as, but not limited to, those discussed in U.S. Pat. No. 5,082,146 (incorporated herein by reference) that describes a membrane within a container that separates different components and is designed to rupture; and U.S. Pat. No. 4,518,103 (incorporated herein by reference) that describes a reserve container that provides delayed release of additional propellant ingredients as the pressure in the container drops. Dividers generally rupture when the pressure on one side of the divider drops, while the pressure on the other side of the divider remains unchanged (or as a result of pressure changes within a pressurized container or gravitational forces, as product is removed from below the divider, in unpressurized containers). Thus, when the relative pressures on different sides of the divider become great enough, the divider will fail (rupture) allowing product on one side of the divider to mix with a material on the other side of the divider.

As discussed above with respect to the structures shown in FIGS. 1-4, depending upon whether the container is a top-first exiting container (FIGS. 5-6) or a bottom-first exiting container that uses a dip tube 120 (FIGS. 7-9), the first portion 110 of the product and the second portion 112 of the product are positioned with respect to the divider layer 130 such that the predetermined quantity of the first portion 110 of the product exits the outlet 108 of the container 100 before (e.g., any of) the second portion 112 of the product exits the outlet 108 of the container 100.

Thus, as shown in FIG. 5, in the top-first exiting container, the indicator colored second portion 112 of the product is positioned in the lower portion of the container 100 below the divider layer 130, while the originally colored unaltered first portion 110 of the product is positioned above the divider layer 130. Note that the outlet 108 can be used to add the unaltered first portion 110 above a divider layer 130 while the fill hole 104 can be used to add the indicator colored second portion 112. FIG. 6 illustrates the container 100 after most of the first portion 110 has exited the container 100 which causes less pressure to exist above the divider 130 than below the divider 130 and causes the divider 130 to rupture. If desired, the divider layer 130 can be connected to the sidewalls of the container 100 to assist in rupturing the divider layer 130 when the pressure imbalance occurs. Once the divider layer 130 ruptures, the second portion 112 of the product is free to move toward the upper portion of the container 100 and eventually exit from the outlet 108.

One feature of the divider layer 130 is that it comprises a structure that can rupture when the predetermined quantity of the first portion 110 of the product has exited the container 100. As would be understood by one ordinarily skilled in the art in light of this disclosure, the material makeup and thickness of the divider layer 130 will vary depending upon the specific material characteristics of the product contained within the container, the amount of pressure (or lack thereof within the container, the vibrational, temperature, and other environmental conditions in which the container will be utilized, as well as other factors. Thus, the thickness and material makeup of the divider layer 130 can be adjusted so that the divider does not rupture prematurely, while ensuring that the divider does rupture when the predetermined quantity of the first portion of the product has exited the container. Therefore, again, the predetermined quantity of the first portion 110 of the product exits the outlet 108 of the container 100 before the second portion 112 of the product exits the outlet 108 of the container 100.

The determination of when any of the dividers, sacks, bubbles, membranes, sub-containers, etc. discussed herein should rupture (and the appropriate design characteristics of various dividers discussed herein) will again depend upon the manufacturer's determination of the appropriate timing for the “low quantity” indicator to begin to appear, taking into consideration how long (in terms of time or quantity of material dispensed) the colored marker 114 will take to disperse within the remaining product and how long it will take the color-changed product to eventually exit the container. Therefore the “predetermined portion” that should exit the container before any of the dividers mentioned herein rupture will vary (e.g., from between less than 1% to more than 99%) depending upon each individual manufacturer's requirements.

One example of when it would be helpful (but not necessary) to have the divider rupture when only a small amount of product has exited can occur with a product that does not have a meaningful risk of mixing after the container 100 is opened, but does have a higher risk of having the first portion 110 mix with the second portion 120 during manufacturing and/or transportation. Therefore, for such a product it may be helpful (but not necessary) to have the membrane rupture at the initial use or opening of the container (e.g., when less than 5% of the product has exited the container). To the contrary, a different container/product combination or different environmental conditions may cause a manufacturer to desire to have the membrane rupture when only a very small amount of product remains because, for example, there may be a higher risk of the first portion 110 mixing with the second portion 120 throughout the useful life of the container/product. Thus, in such a situation, a manufacturer may desire to have the membrane rupture when only a small amount of product is left (e.g., when less than 5% of the product remains in the container).

FIGS. 7-9 illustrate divider layer embodiments that utilizes the dip tube 120. As discussed above, such a container is a bottom-first exiting container and, therefore, the second portion 112 will be placed above the divider layer 130 as shown in FIG. 7. In a similar manner to that shown in FIG. 6, the divider layer 130 can be fixed to the sides of the container 100 so that the divider layer 130 ruptures when the pressure imbalance between the two sides of the divider occurs, thereby permitting the indicator colored second portion 112 to be drawn into the dip tube 120 and provide the user with an indication that the container is becoming empty.

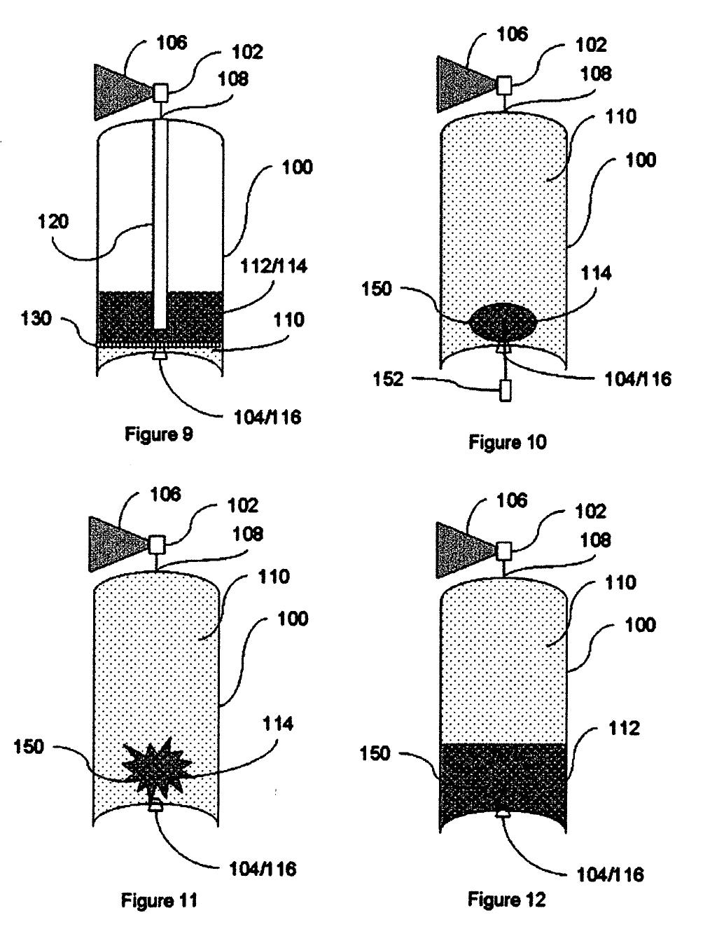

Alternatively, as shown in FIG. 9, the divider layer 130 can be left free from connections to the sides of the container 100 so that the divider layer 130 can float (move, slide) freely within the container 100 and move as the level of the first portion 110 changes as the first portion 110 is consumed (exits). Thus, the structure illustrated in FIG. 9, is useful for unpressurized and pressurized containers that utilize the dip tube 120 and feed from the bottom of the container because the divider 130 (under the influences of gravity) can move down within the container 100 (as the first portion 110 is removed through the dip tube 120) and thereby maintain proper separation of the first portion 110 and the second portion 112. Further, as shown in FIG. 9, when the divider layer 130 drops past the distal end (opening) of the dip tube 120 that is opposite the outlet 108, the indicator colored second portion 112 of the product can be drawn into the dip tube 120, even without rupturing the divider layer 130. For this embodiment, it may be helpful (but not necessary) to adjust the length of the dip tube 120 to permit the divider layer 130 to drop past the opening of the dip tube 120.

While the embodiments shown in FIGS. 5-8 have been discussed as the second portion 112 comprising a mixture of the product and a colored marker 114, in alternative embodiments, the shaded portions in the drawings can comprise the colored marker 114 alone. Thus, when the divider layer 130 ruptures or moves past the distal end of the dip tube 120, the colored marker 114 is released into the originally colored first portion 110 of the product and changes the color of at least some of the first portion 110 to provide a colored indicator to the user that the container is almost empty. In such alternative embodiments, the material makeup and thickness of the divider layer 130 (as well as the quantity of the colored marker 114 utilized) is selected so that the colored indicator 114 can mix with the first portion 110 of the product after the desired predetermined quantity has been released, as discussed above.

Thus, in embodiments herein that uses a divider, the container 100 can maintain the product and a colored marker 114. In these embodiments, the divider within the container 100 separates the product from the marker 114, until the predetermined quantity of the product has exited the container 100, at which time the divider 130 ruptures and colors at least a portion of the remaining product within the container 100, thus forming the colored second portion 112. The marker 114 has a physical characteristic that mixes with the product to change the color of the product from the first color 110 to the second color 112 after it is released from the divider 130.

Other embodiments shown in FIGS. 10-18 maintain the marker 114 or a different colored product, dye, etc. within a sub-container, such as a divider sack 150 or divider bubble 170 (formed from any of the membrane or divider materials discussed herein) within the container 100. In addition, the sub-container can take on any form and be made of any material such as, but not limited to the sub-containers discussed in U.S. Pat. No. 6,363,978 (incorporated herein by reference) that describes a sub-container that opens when the pull tab of a container is operated; U.S. Pat. No. 5,705,209 (incorporated herein by reference) that describes an insert within a pressurized container that shears when the container is opened and adds gas bubbles; U.S. Pat. No. 5,038,964 (incorporated herein by reference) that describes, with respect to a pouch within a pressurized container, that as the pressure on the interior of a container decreases, a stopper is disengaged from a tube, which inflates the pouch until the pouch bursts; U.S. Pat. No. 4,627,986 (incorporated herein by reference) that describes a separate compartment within a beverage container for storing flavoring or sweetener; and U.S. Pat. No. 4,518,103 (incorporated herein by reference) that describes a reserve container that provides delayed release of additional propellant ingredients as the pressure in the container drops. Again, the divider sack 150 or bubble 170 comprises any structure that ruptures as a result of the pressure differential that occurs after a predetermined quantity of the product has exited the container 100. The divider sack 170 can be loose within the container 100 or can remain attached to the container 100. For example, the divider sack 150 can remain attached to the fill hole 104 or seal 116 of the container 100.

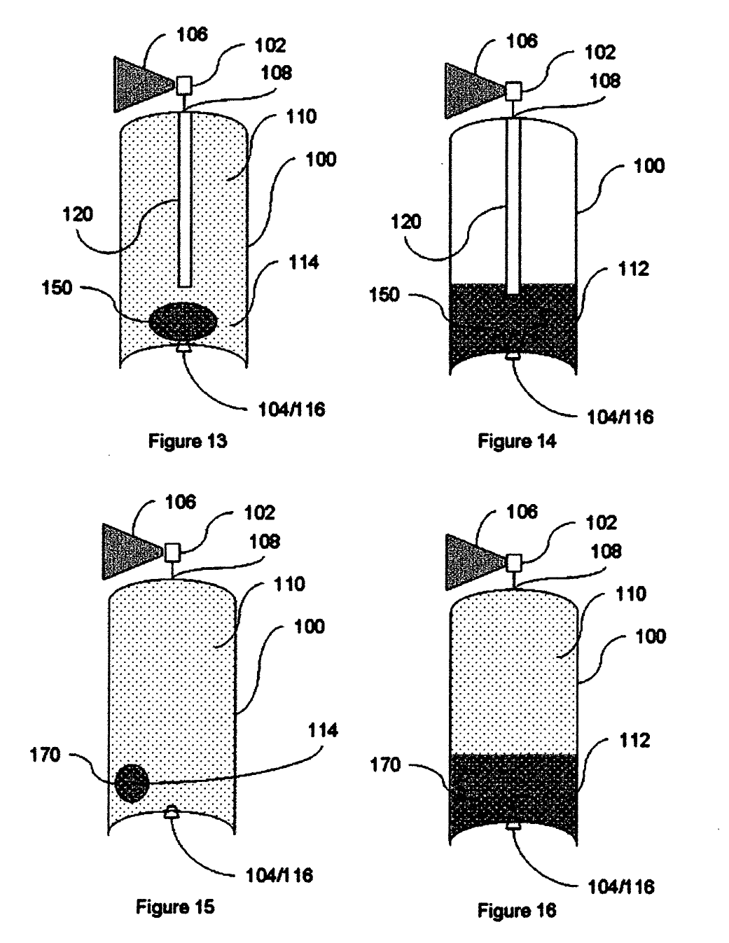

More specifically, as shown in FIG. 10, a divider sack 150 filled with colored marker 114 is formed within a container (or added to the container) which may (or may not) be previously filled with an original colored unaltered first portion 110 of the product. If the divider sack 150 is in a pressurized container, the divider sack 150 is under approximately the same pressure as the remaining first portion 110 within the container (although the pressure within the divider sack 150 can be controlled to be different than the pressure of the first portion 110). As quantities of the first portion 110 exit from the container, the pressure within the container drops, and this causes a pressure differential between the remaining first portion 110 and the colored marker 114 within the divider sack 150. When this pressure differential reaches a predetermined point, the divider sack 150 will rupture as shown in FIG. 11. The colored marker 114 will then spread to at least a portion of the product and create the second portion 112 of the product (discussed above) that has a changed color and comprises the indicator to the user that the container 100 is becoming empty. As shown in FIGS. 13 and 14, this embodiment is equally useful with a container that utilizes a dip tube 120 (where the positions of the first portion 110 and the second portion 112 are reversed) so long as the size and/or the position of dip tube 120 does not prematurely rupture the divider sack 150, 170.

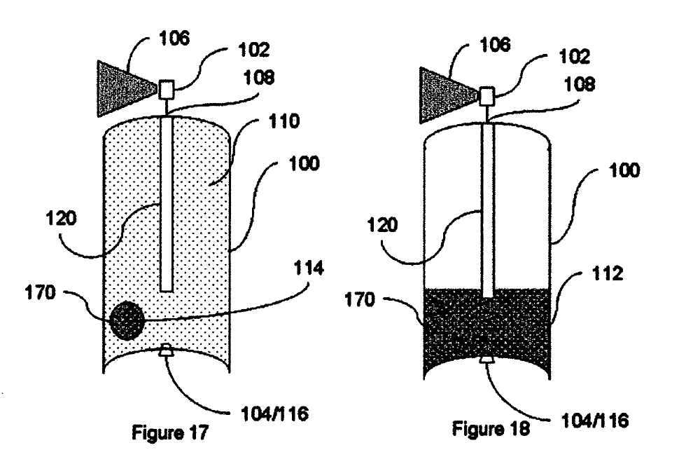

As shown in FIGS. 15-18, similar embodiments can use a divider bubble 170 that is not attached to the container 100 or fill hole 104. Instead, the divider bubble 170 is loose within the container 100 as illustrated in FIG. 15 (and FIG. 17 for the dip tube 120 embodiment). As illustrated in FIGS. 16 and 18, when the pressure differential between the unaltered first portion 110 of the product and the divider bubble 170 becomes great enough and exceeds a predetermined point, the divider bubble 170 will rupture and create the second portion 112, as discussed above. As with the embodiments shown in FIGS. 1-4, the top-first emptying containers will reverse the positions of the first portion 110 and the second portion 112 when compared to the bottom-first emptying containers.

Methods for making the above apparatus embodiments are many. In one method embodiment, the product is added to the container 100 and a colored marker 114 is added to the container 100 to leave the first portion 110 of the product with the first color and the second portion 112 of the product with the second color. When so adding the product 110 and the colored marker 114, the process is performed in a method wherein the first portion 110 of the product is positioned relative to the second portion 112 of the product within the container 100 such that the predetermined quantity of the first portion 110 of the product exits the outlet 108 of the container 100 before the second portion 112 of the product exits the outlet 108 of the container 100. Again, the process of adding the colored marker 114 changes the color of the second portion 112 from the first color to the second color. However, in another embodiment, rather than adding the colored marker 114, the different colored product 112 (second color) is added after the first color product is added.

As shown in FIG. 1, if the container 100 is filled through the top outlet 108, this can be accomplished by adding the marker 114 (or the “low quantity” indicator colored second portion 112) to the container 100 before the first portion 110 is added to the container, using any form of commonly known filler apparatus 155. To the contrary, if the structure shown in FIG. 1 is filled through the bottom fill hole 104, the first portion 110 is added to the container and then the indicator colored second portion 112 is added to the container. Then, the bottom fill hole 104 is sealed with any form of seal 116 including but not limited to a cork, stopper, solder, glue, gasket, etc. and the top outlet 108 is sealed with the valve/pump assembly 102.

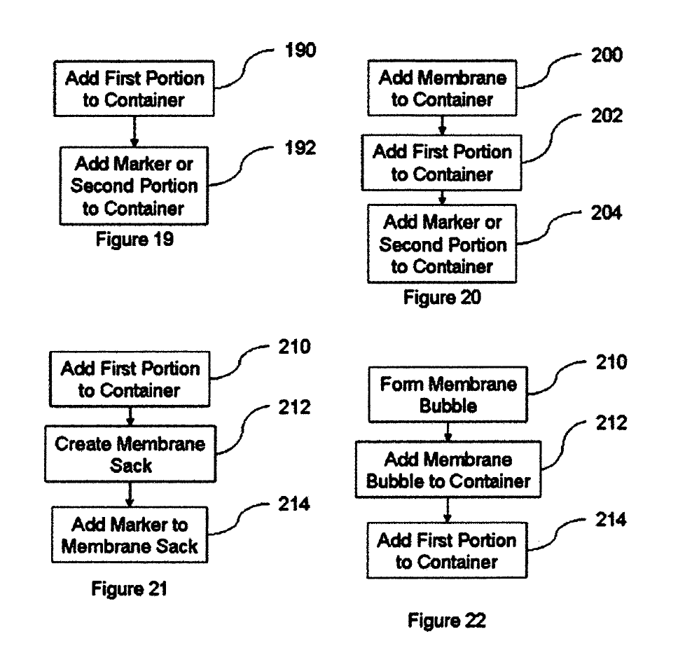

In an alternative method, the first portion 110 can be added to the container through the outlet 108 and the second portion 112 can be added to the container through the fill hole 104 and/or seal 116. In a further alternative method, the container can be completely filled with the originally colored unaltered first portion 110 of the product and the seal 116 can be fitted to the fill hole 104. Then, the marker 114 can be injected through the fill hole 104 using, for example, a syringe or similar apparatus 152 (e.g., through the seal 116 that closes the fill hole 104). The injected marker 114 material mixes with the lower portion of the product within the container to create the indicator colored second portion 112 of the product. The structure shown in FIG. 3 can be formed by similar methods that reverse the positions of the first portion 110 and a second portion 112. This process is shown in flowchart form in FIG. 19 where, in item 190, the first portion is added to the container, and in item 192, the marker 114 or the second portion 112 is added to the container.

Also, the structure shown in FIGS. 5 and 7 can be formed by similar processes that start with an otherwise empty container 100 fitted with the divider layer 130. Thus, the first portion 110 can be added to one side of the divider layer 130 sequentially or simultaneously with the second portion 112 or marker 114 being added to the other side of the divider layer 130. Alternatively, the unaltered first portion 110 can be added to both sides of the divider 130, and then product on one side of the divider 130 can be changed in color to the second color to become the second portion 112 by injection/addition of the coloring agent 114. This is shown in flowchart form in FIG. 20 where, in item 200, the divider is fitted within or added to the container. In item 202, the first portion 110 is added to the container 100 and, in item 204, the second portion 112 or the marker 114 is added to the container.

Thus, in one embodiment, the same originally colored unaltered product 110 can be placed on both sides of the divider layer 130, the fill hole 104 and/or outlet 108 can be sealed and then a predetermined portion of the marker 114 can be injected through the seal 116 that closes the fill hole 104 and/or the outlet 108 to cause the product on one side of the divider layer 130 to take on the indicator color of the marker 114 and become the second portion 112. Thus, method embodiments herein can add a divider 130 to the container 100, add the product to a container 100, and add a colored marker 114 to the container 100 (not necessarily in that order) such that the product is separated from the marker 114 by the divider 130. Again, the divider 130 comprises a structure that ruptures after a predetermined quantity of the product has exited the container 100 and the marker 114 has a physical characteristic that changes the color of the product from the first color to the second color after the divider 130 ruptures.

An additional method embodiment adds the product to the container 100, adds (or creates) the sub-container (divider sack 150 or divider bubble 170) to the container 100, and fills the divider sack 150, 170 with a colored marker 114. The divider bubble 170 can be filled before or after being added to the container 100. More specifically, the divider sack 150 can be formed by adding/injecting a predetermined amount of divider material through the fill hole 104 and/or seal 114 to leave a structure similar to a deflated balloon. The subsequent addition/injection of marker 114 material fills the deflated balloon structure and creates a sack or bubble of divider material 150, 170 as the colored marker 114 material expands the divider material added through the fill hole 104 or seal 114. This process is controlled to adjust the relative pressure within the sub-container compared to the pressure within the container outside the sub-container to ensure that the sub-container ruptures when the predetermined quantity of first portion 110 has exited the container 100. Then, the divider sack 150 can remain attached to the fill hole 104 or can be separated therefrom to become a free-floating divider bubble 170. This is shown in flowchart form in FIG. 21 where, in item 210 the first portion is added to the container, in item 212 the divider sack 150 is created, and in item 214 the marker 114 is added to the divider sack 150.

In an alternative embodiment regarding the use of a divider bubble 170, the divider bubble (ball) 170 can be created separately from the container 100 and be added to the container 100 before any of (or while) the product is added to the container. It may be helpful (but not necessary) to maintain the divider bubble 170 in a pressurized condition until the product can be added to the container and the container becomes pressurized so that the marker 114 material within the divider bubble 170 is pressurized (which, as described above, helps the rupturing of the divider bubble 170). This is shown in flowchart form in FIG. 22, where the divider bubble is formed in item 210. In item 212, the divider bubble 170 is added to the container, and in item 214 the product is added to the container.

Thus, as shown above, the embodiments herein provide the user with a warning that the product within the container is about to run out so that the user can obtain a full container before the previous container becomes completely empty. The embodiments herein provide this visual indicator to the user by changing the color of the product as the quantity in the container empties.

While the invention has been described in terms of exemplary embodiments, those skilled in the art will recognize, after reviewing this disclosure, that the invention can be practiced with modification within the spirit and scope of the appended claims. For example, while many different types of containers were discussed above, the invention is not limited to only those specific containers, but instead is applicable to all containers that have the ability to dispense a different colored product as the container empties, so as to advise the user that the container will be empty soon. Similarly, while some method examples have been discussed above, the invention is not limited to just those exemplary methods, but instead is applicable to all methods that form containers that have the ability to dispense a different colored product as the container empties, again to advise the user that the container will be empty soon. As a further example of the applicability of the invention described herein, while two colors have been discussed above, one ordinarily skilled in the art would understand that three, four, or more colors could be used by embodiments herein to indicate different product quantity levels (through the use of three or more portions, multiple dividers/sub-containers structured to rupture at different pressure conditions, etc.) and that the term “second color” would be understood by one ordinarily skilled in the art to potentially mean more than one color. Therefore, while the invention has been discussed with respect to various exemplary embodiments, the invention is not limited to these embodiments.

1-5. (canceled)

6. An apparatus comprising:
a container maintaining a product, said container comprising an outlet, said product comprising a first portion and a second portion; and
a divider within said container separating said first portion of said product from said second portion of said product, wherein:
said first portion of said product has a first color;
said second portion of said product has a second color that is visually distinguishable from said first color, wherein said second portion comprises said product and a coloring agent; and
said second portion of said product is positioned with respect to said divider and to said first portion such that said first portion of said product exits said outlet of said container before said second portion of said product exits said outlet of said container.

7. The apparatus according to claim 6, wherein said coloring agent is absent from said first portion of said product.

8. The apparatus according to claim 6, wherein said first portion of said product is positioned relative to said second portion of said product within said container such that substantially all of said first portion of said product exits said outlet of said container before said second portion of said product exits said outlet of said container.

9. The apparatus according to claim 6, wherein said container comprises one of a pressurized container and an unpressurized container.

10. The apparatus according to claim 6, wherein said outlet comprises one of a valve and a pump dispensing said product.

11. An apparatus comprising:
a container maintaining a product, said container comprising an outlet,
said product comprising a first portion and a second portion; and
a divider within said container separating said first portion of said product from said second portion of said product, wherein:
said first portion of said product has a first color;
said second portion of said product has a second color that is visually distinguishable from said first color, wherein said second portion comprises said product and a coloring agent;
said divider comprises a structure that ruptures when a predetermined quantity of said first portion of said product has exited said container; and
said second portion of said product is positioned with respect to said divider such that said second portion of said product exits said outlet of said container after said divider ruptures.

12. The apparatus according to claim 11, wherein said coloring agent is absent from said first portion of said product.

13. The apparatus according to claim 11, wherein said first portion of said product is positioned relative to said second portion of said product within said container such that substantially all of said first portion of said product exits said outlet of said container before said second portion of said product exits said outlet of said container.

14. The apparatus according to claim 11, wherein said container comprises one of a pressurized container and an unpressurized container.

15. The apparatus according to claim 11, wherein said outlet comprises one of a valve and a pump dispensing said product.

16. An apparatus comprising:
a container maintaining a product, said container comprising an outlet; and
a sub-container within said container maintaining a coloring agent, wherein:
said product has a first color;
said coloring agent comprises a material that changes a color of at least a portion of said product from said first color to a second color that is visually distinguishable from said first color; and
said sub-container comprises a structure that ruptures when a predetermined quantity of said product has exited said container.

17. The apparatus according to claim 16, wherein said coloring agent is absent from said product until said sub-container ruptures.

18. The apparatus according to claim 16, wherein said product comprises a first portion having said first color and a second portion having said second color, and wherein said first portion of said product is positioned relative to said second portion of said product within said container such that substantially all of said first portion of said product exits said outlet of said container before said second portion of said product exits said outlet of said container.

19. The apparatus according to claim 16, wherein said container comprises one of a pressurized container and an unpressurized container.

20. The apparatus according to claim 16, wherein said outlet comprises one of a valve and a pump dispensing said product.

21. A method comprising:
adding a product to a container; after said adding of said product to said container, sealing said container with a seal; and injecting a coloring agent into said container through said seal to leave a first portion of said product with a first color and a second portion of said product with a second color that is visually distinguishable from said first color, wherein said adding of said product and said injecting of said coloring agent is performed in a process wherein said first portion of said product is positioned relative to said second portion of said product within said container such that a predetermined quantity of said first portion of said product exits an outlet of said container before said second portion of said product exits said outlet of said container.

22. The method according to claim 21, wherein said injecting of said coloring agent changes a color of said second portion from said first color to said second color.

23. The method according to claim 21, wherein said predetermined quantity comprises substantially all of said first portion of said product.

24. The method according to claim 21, wherein said injecting of said coloring agent avoids adding said coloring agent to said first portion of said product.

25. The method according to claim 21, wherein said adding of said product and said injecting of said coloring agent is performed to create one of a pressurized environment within said container and an unpressurized environment within said container.

26. A method comprising:
adding a first portion of a product having a first color to a container;
after said adding of said first portion of said product of said container, sealing said container with a seal; and
injecting a second portion of said product having a second color that is visually distinguishable from said first color into said container through said seal,
wherein said second portion comprises said product and a coloring agent, and
wherein said adding of said first portion and said injecting of said second portion is performed in a process wherein said first portion of said product is positioned relative to said second portion of said product within said container such that a predetermined quantity of said first portion of said product exits an outlet of said container before said second portion of said product exits said outlet of said container.

27. The method according to claim 26, wherein said coloring agent changes a color of said second portion from said first color to said second color.

28. The method according to claim 26, wherein said predetermined quantity comprises substantially all of said first portion of said product.

29. The method according to claim 26, wherein said coloring agent is absent from said first portion of said product.

30. The method according to claim 26, wherein said adding of said first portion and said injecting of said second portion is performed to create one of a pressurized environment within said container and an unpressurized environment within said container.

31. A method comprising:
adding a divider to a container;
adding a product having a first color to said container; and
adding a coloring agent having a second color that is visually distinguishable from said first color to said container such that at least a portion of said product is separated from said coloring agent by said divider,
wherein said divider comprises a structure that ruptures after a predetermined quantity of said product has exited said container.

32. The method according to claim 31, wherein said coloring agent changes a color of said product from said first color to said second color.

33. The method according to claim 31, wherein said adding of said product and said adding of said coloring agent is performed to create one of a pressurized environment within said container and an unpressurized environment within said container.

34. The method according to claim 31, wherein said adding of said product and said adding of said coloring agent is performed one of sequentially and simultaneously.

35. A method comprising:
adding a divider to a container;
adding a first portion of a product having a first color to said container; and
adding a second portion of said product having a second color that is visually distinguishable from said first color to said container such that said first portion is separated from said second portion by said divider,
wherein said second portion comprises said product and a coloring agent, and
wherein said divider comprises a structure that ruptures after a predetermined quantity of said first portion has exited said container.

36. The method according to claim 35, wherein said coloring agent changes a color of said second portion from said first color to said second color.

37. The method according, to claim 35, wherein said predetermined quantity comprises substantially all of said first portion of said product.

38. The method according to claim 35, wherein said coloring agent is absent from said first portion of said product.

39. The method according to claim 35, wherein said, adding of said first portion and said adding of said second portion is performed to create one of a pressurized environment within said container and an unpressurized environment within said container.

40. A method comprising:
adding a product having a first color to a container;
adding a sub-container to said container; and
adding a coloring agent having a second color that is visually distinguishable from said first color to said sub-container such that said product is separated from said coloring agent by said sub-container,
wherein said sub-container comprises a structure that ruptures after a predetermined quantity of said product has exited said container.

41. The method according to claim 40, wherein said coloring agent changes a color of said product after said sub-container ruptures.

42. The method according to claim 40, wherein said adding of said coloring agent avoids adding said coloring agent to said first portion of said product.

44. The method according to claim 41, wherein said adding of said product and said adding of said coloring agent is performed to create one of:
a pressurized environment within said container and said sub-container; and
an unpressurized environment within said container and said sub-container.

45. The method according to claim 41, wherein said adding of said product, said adding of said sub-container, and said adding of said coloring agent are performed in any order.
